(19) United States
(12) Patent Application Publication
(10) Pub. No.: US 2024/0391261 A1
(43) Pub. Date: Nov. 28, 2024

(54) MOTOR DRIVE CONTROL METHOD AND MOTOR DRIVE CONTROLLER OF IMAGE-FORMING APPARATUS, AND STORAGE MEDIUM

(71) Applicant: Zhuhai Pantum Electronics Co., Ltd., Zhuhai (CN)

(72) Inventors: Zhe SHAO, Zhuhai (CN); Yihong ZHANG, Zhuhai (CN)

(21) Appl. No.: 18/655,331

(22) Filed: May 6, 2024

(30) Foreign Application Priority Data
May 26, 2023 (CN) 202310612565.4

(51) Int. Cl. B41J 13/00; B41J 13/02

(52) U.S. Cl. CPC B41J 13/0009; B41J 13/02

(57) ABSTRACT

The present disclosure provides a motor drive control method of an image-forming apparatus, a motor drive controller, and a storage medium. The image-forming apparatus includes a medium-conveying part, and a motor configured to provide a driving force for the medium-conveying part. The motor drive control method includes, before the medium-conveying part conveys a medium, executing a first control strategy to control the motor to rotate at a target rotation speed; and when the medium-conveying part conveys the medium, switching to execute a second control strategy to control the motor to drive the medium-conveying part to convey the medium at the target rotation speed.

### CROSS-REFERENCE TO RELATED APPLICATION

The present disclosure claims the priority to Chinese patent application No. 202310612565.4, filed on May 26, 2023, the entirety of which is incorporated herein by reference.

### TECHNICAL FIELD

The present disclosure generally relates to the field of image-forming technology and, more particularly, relates to a motor drive control method and a motor drive controller of an image-forming apparatus, and a storage medium.

### BACKGROUND

Image-forming apparatuses perform image-forming jobs such as generating, printing, receiving, and transmitting image data. Exemplarily, the image-forming apparatuses may include printers, scanners, copiers, fax machines, and multi-functional peripherals (MFP) that perform above functions in a single device.

The image-forming apparatus is disposed with a motor for providing a driving force for the operation of the image-forming apparatus. Papers are moved from a paper feeding tray to a paper path and then to an image-forming assembly, and transferred papers are discharged through a paper discharging assembly. In above process, the motor is needed to provide the driving force. However, a load of the motor may change during a paper conveying process, which may cause the conveying speed of the papers to fluctuate. When the conveying speed fluctuates, the transferring quality may be affected, such as transferring position may change.

### SUMMARY

One aspect of the present disclosure provides a motor drive control method of an image-forming apparatus, where the image-forming apparatus includes a medium-conveying part, and a motor configured to provide a driving force for the medium-conveying part. The method includes, before the medium-conveying part conveys a medium, executing a first control strategy to control the motor to rotate at a target rotation speed; and when the medium-conveying part conveys the medium, switching to execute a second control strategy to control the motor to rotate at the target rotation speed to drive the medium-conveying part to convey the medium.

Another aspect of the present disclosure provides a motor drive controller of an image-forming apparatus. The image-forming apparatus includes a medium-conveying part, and a motor configured to provide a driving force for the medium-conveying part. The motor drive controller includes a memory storing program instructions; and a processor communicatively coupled to the memory and, when the program instructions being executed, configured to: before the medium-conveying part conveys a medium, execute a first control strategy to control the motor to rotate at a target rotation speed; and when the medium-conveying part conveys the medium, switch to execute a second control strategy to control the motor to rotate at the target rotation speed to drive the medium-conveying part to convey the medium at the target rotation speed.

Another aspect of the present disclosure provides a non-transitory computer-readable storage medium containing a stored program, that when being executed, causes a device where the non-transitory computer-readable storage medium is located to execute a motor drive control method of an image-forming apparatus, where the image-forming apparatus includes a medium-conveying part, and a motor configured to provide a driving force for the medium-conveying part. The method includes before the medium-conveying part conveys a medium, executing a first control strategy to control the motor to rotate at a target rotation speed; and when the medium-conveying part conveys the medium, switching to execute a second control strategy to control the motor to rotate at the target rotation speed to drive the medium-conveying part to convey the medium.

Other aspects of the present disclosure may be understood by those skilled in the art in light of the description, the claims, and the drawings of the present disclosure.

### BRIEF DESCRIPTION OF THE DRAWINGS

To clearly describe technical solutions of various embodiments of the present disclosure, the drawings which need to be used for describing various embodiments are described below. Obviously, the drawings in the following description are merely some embodiments of the present disclosure. For those skilled in the art, other drawings may be obtained in accordance with the drawings without creative efforts.

FIG. 1 illustrates a structural schematic of an image-forming apparatus provided by exemplary embodiments of the present disclosure.

FIG. 2 illustrates a schematic of a motor drive control architecture of an image-forming apparatus provided by exemplary embodiments of the present disclosure.

FIG. 3 illustrates a flowchart of a motor drive control method of an image-forming apparatus provided by exemplary embodiments of the present disclosure.

FIG. 4 illustrates a medium-conveying schematic of a medium-conveying part provided by exemplary embodiments of the present disclosure.

FIG. 5 illustrates another medium-conveying schematic of a medium-conveying part provided by exemplary embodiments of the present disclosure.

FIG. 6 illustrates another schematic of a motor drive control architecture of an image-forming apparatus provided by exemplary embodiments of the present disclosure.

FIG. 7 illustrates a schematic of determining that a medium enters a first preset region provided by exemplary embodiments of the present disclosure.

FIG. 8 illustrates a schematic of first preset time classification provided by exemplary embodiments of the present disclosure.

FIG. 9 illustrates another schematic of a motor drive control architecture of an image-forming apparatus provided by exemplary embodiments of the present disclosure.

FIG. 10 illustrates a schematic of control strategy switching provided by exemplary embodiments of the present disclosure.

FIG. 11 illustrates another schematic of control strategy switching provided by exemplary embodiments of the present disclosure.

FIG. 12 illustrates a schematic of a medium-conveying scenario provided by exemplary embodiments of the present disclosure.

FIG. 13 illustrates another schematic of control strategy switching provided by exemplary embodiments of the present disclosure.

FIG. 14 illustrates a structural schematic of a motor drive controller of an image-forming apparatus provided by exemplary embodiments of the present disclosure.

FIG. 15 illustrates a structural schematic of a motor drive controller of an image-forming apparatus provided by exemplary embodiments of the present disclosure.

FIG. 16 illustrates a structural schematic of an image-forming apparatus provided by exemplary embodiments of the present disclosure.

### DETAILED DESCRIPTION

In order to clearly illustrate the objectives, technical solutions and advantages of embodiments of the present disclosure, the technical solutions in embodiments of the present disclosure are clearly and completely described below in conjunction with the drawings in embodiments of the present disclosure. Obviously, described embodiments are a part of embodiments of the present disclosure, but not all of embodiments of the present disclosure. According to embodiments in the present disclosure, all other embodiments obtained by those skilled in the art without creative efforts fall within the protection scope of the present disclosure. In addition, “plurality” mentioned in embodiments of the present disclosure refers to two or more.

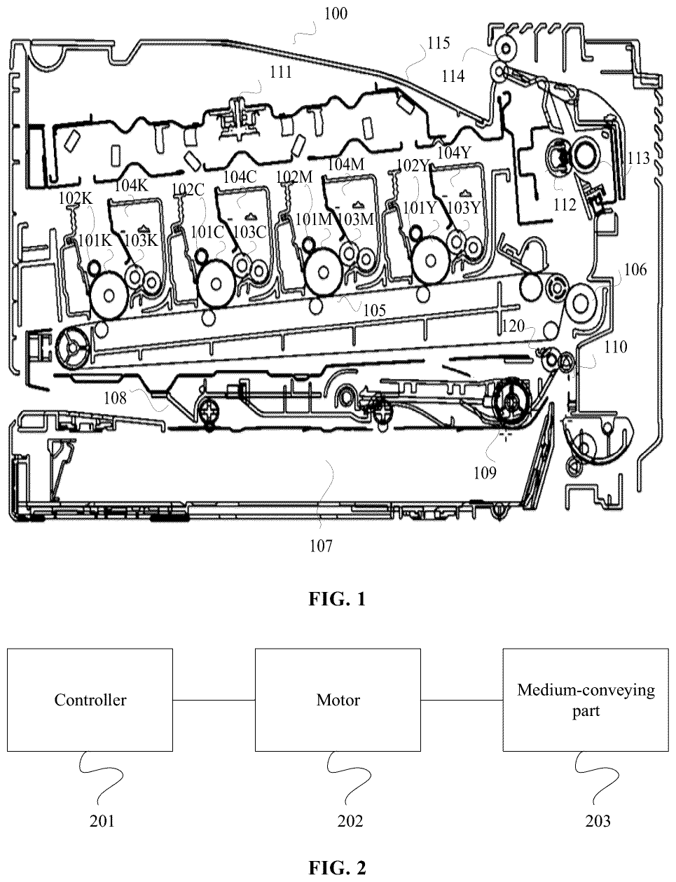

FIG. 1 illustrates a structural schematic of an image-forming apparatus provided by exemplary embodiments of the present disclosure.

Referring to FIG. 1, an image-forming apparatus 100 may be configured to perform image-forming jobs such as generating, printing, receiving and transmitting image data. In addition, exemplarily, the image-forming apparatus 100 may include a printer, a scanner, a copier, a fax machine, and a multi-function peripheral (MFP) that performs above functions in a single device.

Exemplarily, the image-forming apparatus 100 may include a process cartridge, a transferring belt 105, a secondary transferring roller 106, a paper feeding tray 107, a manual paper feeding tray 108, a pickup roller (feeding roller) 109, a conveying roller 110, a paper detection sensor 120, a laser scanning unit (LSU) 111, a fixing unit (including a fixing roller 112 and a pressing roller 113), a discharging roller 114, a paper discharging tray 115 and the like. The process cartridge may be a consumable of the image-forming apparatus 100. In FIG. 1, the image-forming apparatus 100 may be capable of printing multiple colors; and may include four color process cartridges which are a process cartridge K (black), a process cartridge C (cyan), a process cartridge M (magenta), and a process cartridge Y (yellow) respectively. The process cartridges K-Y may respectively include photosensitive drums 101 (K-Y), charging rollers 102 (K-Y), developing rollers 103 (K-Y) and toner bins 104 (K-Y) for holding corresponding color toners. In addition, the image-forming apparatus 100 may also be a monochrome printer including only the process cartridge K (black).

The LSU 111 may be in the form of a single LSU and include four optical paths. Four charging rollers 102 (K, C, M and Y) may be configured to charge the surfaces of four photosensitive drums 101 (K, C, M and Y) respectively. Four optical paths of LSU 111 may respectively emit laser beams to form electrostatic latent images on the surfaces of photosensitive drums 101 (K, C, M and Y). Four developing rollers 103 (K, C, M and Y) may be configured to respectively develop a toner image of one color on the surfaces of the photosensitive drums 101 (K, C, M and Y). The image-forming apparatus 100 may use a secondary transferring manner; that is, four photosensitive drums 101 (K, C, M and Y) may sequentially transfer the toner images to the transferring belt 105, and the color toner images formed on the transferring belt 105 may be secondarily transferred to the paper via the secondary transferring roller 106. The paper feeding tray 107 may be configured to store paper, and the pickup roller 109 may be configured to convey stored paper to a convey path (i.e., the paper path described below). The conveying roller 110 may convey the paper to the secondary transferring roller 106.

The secondary transferring roller 106 may convey the paper with the toner image to the clamping region of the heating roller 112 and the pressing roller 113. The heating roller 112 and the pressing roller 113 may be configured to fix the toner image on the paper. The heating roller 112 may use a ceramic heating manner. The heating roller 112 and the pressing roller 113 may convey the fixed paper to the discharging roller 114, and the discharging roller 114 may discharge the paper to the discharging paper tray 115 to be stacked with each other.

The laser scanning unit may implement the image-forming process through the light beams emitted from four light sources (such as LEDs) respectively incident on each photosensitive drum after passing through polygon mirrors and optical systems. The paper detection sensor 120 may be configured to detect whether paper is in the paper path where the paper detection sensor 120 is located.

The paper feeding tray 107 may be disposed with a paper outlet, and the pickup roller 109 may be configured to send the paper accommodated in the paper feeding tray 107 from the paper outlet into the paper path for transferring need. The image-forming apparatus 100 may also include a driving mechanism (not shown in drawings) for driving the pickup roller 109 to operate. The driving mechanism may be a driving motor for driving the pickup roller 109 to move to implement the pickup operation. The driving mechanism 181 may be electrically connected to a controller (not shown in drawings) of the image-forming apparatus, such that the controller may control the operation of the driving mechanism. The controller may be electrically connected to the paper detection sensor 120. The paper detection sensor may send detection result information of whether paper is in the paper path to the controller.

The image-forming apparatus 100 may further include an operation panel (not shown in drawings). The operation panel may include an operation portion (not shown in drawings) formed by various keys and a touch-panel-type display portion (not shown in drawings).

It may be understood that the image-forming apparatus 100 mentioned above may be only exemplary; and structures and arrangement of the parts of the image-forming apparatus 100 may be adjusted according to actual condition without affecting improvement solution of the present disclosure.

FIG. 2 illustrates a schematic of a motor drive control architecture of the image-forming apparatus provided by exemplary embodiments of the present disclosure.

Referring to FIG. 2, the image-forming apparatus may include a controller 201, a motor 202, and a medium-conveying part 203. The controller 201 may be communicatively connected to the motor 202 and may control the motor 202 to drive the medium-conveying part 203 according to different control strategies. The medium-conveying part 203 may include at least one of the following: a paper feeding roller, a conveying roller, a correction roller, a transferring roller (also referred to as the secondary transferring roller), a fixing roller, and a discharging roller. The medium conveyed by the medium-conveying part 203 may be medium for printing images, such as paper, cloth, sheet and the like. The controller 201 may be a main controller disposed on the image-forming apparatus, or an independent controller that independently controls the motor, or a member of overall control system disposed on the apparatus main body, or other control implementation parts. The controller 201 may also include an MCU (microcontroller unit) and other circuit units connected to the MCU, which may not be limited in the present disclosure.

In some embodiments, the controller 201 may obtain at least two different control strategies. Before the medium-conveying part 203 starts conveying the medium, one of the control strategies may be executed to control the motor 202 to rotate; and when the medium-conveying part 203 conveys the medium, another different control strategy may be executed to control the motor 202 to drive the medium-conveying part 203. Therefore, the rotation speed of the motor 202 when the medium is not conveyed may be same as the rotation speed of the motor 202 when the medium is conveyed, thereby ensuring the stability and consistency of the medium-conveying speed by the medium-conveying part and improving the medium image-forming quality.

In some embodiments, at least two different control strategies obtained by the controller 201 may include at least one of the following: obtaining at least two different control strategies prestored locally from the image-forming apparatus; obtaining at least two different control strategies prestored from external memory of the image-forming apparatus; or obtaining at least two different control strategies from the cloud to which the image-forming apparatus is connected.

During the medium conveying process, a relatively long time is taken for the motor to reach the target rotation speed from startup. If the motor starts to rotate from startup and convey the medium, correspondingly, the motor may have a long acceleration process before the motor reaches the target rotation speed and have a wide range of speed fluctuation when the motor reaches the target rotation speed. As a result, a long time may be taken to adjust the conveying speed of the medium-conveying part, which may seriously affect the conveying efficiency and hinder the image-forming control process.

Therefore, in order to realize a stable conveying speed of the medium, the motor may be started in advance and rotate to a stable state of the target rotation speed. When the medium needs to be conveyed by the medium-conveying part, the motor may quickly achieve the objective of driving the medium-conveying part to convey the medium at the target conveying speed.

However, during the motor control process, especially at the moment when the medium starts to be conveyed by the medium-conveying part, the load on the medium-conveying part may become larger. As a result, the load on the motor may increase accordingly to cause the speed of the motor to decrease instantaneously, and a long fluctuation time may be needed before the motor can be readjusted back to the target rotation speed, which may affect internal control process of the image-forming apparatus on medium conveying and image formation.

Therefore, the present disclosure provides following motor drive control method applied to the image-forming apparatus. The motor drive control method may be applied to the image-forming apparatus. For example, the motor drive control method may be executed by a control unit provided inside the image-forming apparatus, and the control unit may include the controller 201 mentioned above.

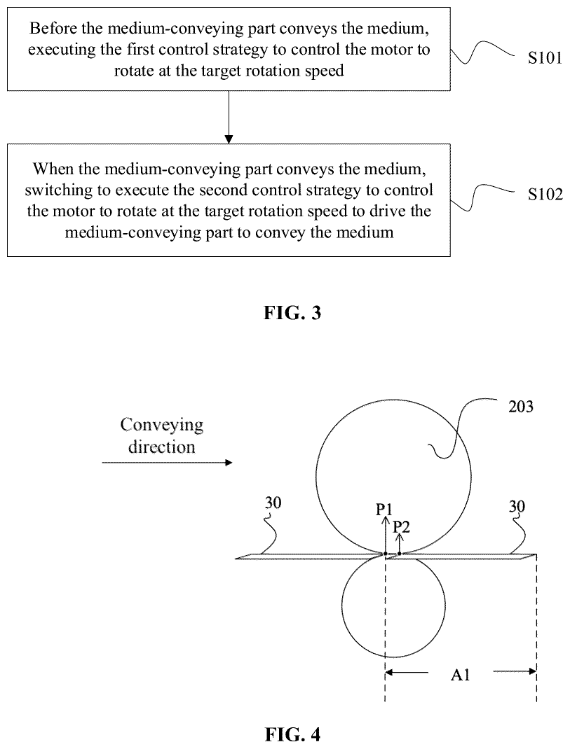

FIG. 3 illustrates a flowchart of a motor drive control method of the image-forming apparatus provided by exemplary embodiments of the present disclosure.

Referring to FIGS. 2-3, the method may include following exemplary steps.

At S101, before the medium-conveying part conveys a medium, the first control strategy may be executed to control the motor to rotate at a target rotation speed.

At S102, when the medium-conveying part conveys the medium, the first control strategy may be switched to the second strategy being executed to control the motor to rotate at the target rotation speed to drive the medium-conveying part to convey the medium at the target rotation speed.

Exemplary step S101 is described hereinafter.

In order to ensure the time sequence synchronization between the image-forming process and the medium conveying process inside the image-forming apparatus, the first control strategy may be executed to control the motor to stabilize at the idle state at the target rotation speed. Under the first control strategy, the motor may be maintained at the target rotation speed in the idle state, and the rotation speed may be stable to be in the standby state.

It should be noted that the idle state refers to the rotational state when the motor does not drive the medium-conveying part to convey the medium. The load may be relatively small compared to conveying the medium. Such rotation state may include, but may not be limited to, one of two following scenarios: the medium-conveying part may be disengaged from the motor, and the motor may drive the medium-conveying part into a rotation state in which the medium is not conveyed.

Exemplary step S102 is described hereinafter.

The moment that the medium-conveying part starts conveying the medium may be the moment that the medium starts to be conveyed by the medium-conveying part. Such moment may be the moment that the medium-conveying part may be switched from the stopped state to the rotating state to convey the medium in the preset conveying direction; may also be the moment that the medium may be conveyed to a preset region of the medium-conveying part and conveyed by the medium-conveying part when the medium-conveying part is in the rotating state; and may also be other situations that the medium starts to be conveyed by the medium-conveying part, which may be included in the implementation scope of the present disclosure.

In one embodiment, the manner of determining that the medium-conveying part starts conveying the medium may include determining that the motor drives the medium-conveying part to start conveying the medium based on a medium conveying command sent by the image-forming apparatus. In order to cooperate with the image-forming process, the image-forming apparatus may send the medium conveying command to the conveying control unit through the main controller or other controllers used to control the medium conveying time sequence; and the conveying control unit may control the motor to start driving the medium-conveying part based on the command, such that the medium-conveying part may convey the medium.

The image-forming apparatus may further include a clutch part. The clutch part may be a power transmission part of the conveying control unit and configured to transmit or cut off the driving force provided by the motor to the medium-conveying part. In such way, the motor driving the medium-conveying part to start conveying the medium may include following exemplary step: sending a clutch closing signal to the clutch part to close the clutch part, thereby making the motor drive the medium-conveying part.

The clutch closing signal may be included in the medium conveying command. That is, the clutch closing signal contained in the medium conveying command sent by the controller that controls the conveying time sequence may be directly sent to the clutch part of the conveying control unit to close the clutch. Optionally, the conveying control unit may include independent control parts, and the medium conveying command may not contain the clutch closing signal. When the control part of the conveying control unit receives the medium conveying command, the control part may send the clutch closing signal to the clutch part, and the clutch part may be closed according to the clutch closing signal, such that the driving force of the motor may be transmitted to the medium-conveying part.

That is, when the image-forming apparatus sends medium conveying command and directly controls the motor to drive the medium-conveying part to convey the medium, the controller 201 may directly determine that the motor starts driving the medium-conveying part based on the medium conveying command. For such scenario, the controller 201 may determine the time point when the motor starts driving the medium-conveying part to convey the medium to be the moment when the controller 201 sends the medium conveying command or a short period of time after the controller 201 sends the medium conveying command, which may not be limited in embodiments of the present disclosure.

When the image-forming apparatus sends the medium conveying command and the clutch closing signal, the motor may be controlled to drive the medium-conveying part to convey the medium, such that the controller 201 may finally determine that the motor starts to drive the medium-conveying part based on the clutch closing signal. For example, the controller 201 may determine the time point when the motor starts to drive the medium-conveying part to convey the medium to be the moment when the controller 201 completes sending the clutch closing signal, or a short period of time after the controller 201 sends the clutch closing signal, which may not be limited in embodiments of the present disclosure.

FIG. 4 illustrates a medium-conveying schematic of a medium-conveying part provided by exemplary embodiments of the present disclosure.

Referring to FIG. 4, at the conveying scenario of the medium 30 in some embodiments, according to the medium-conveying direction, the medium 30 may stay on the medium-conveying part 203 or may be at the front position of the medium-conveying part 203, that is, the P1 position. At this point, the clutch part between the medium-conveying part 203 and the motor may be opened, the medium-conveying part 203 may be in a disengaged state from the motor, and the motor may be idling at the target rotation speed.

For example, the medium-conveying part 203 may be a correction roller in the image-forming apparatus, and the clutch part may be a clutch. When the medium reaches the correction roller and is corrected by the correction roller, the correction roller may be in a non-rotation state, and the motor used to drive the correction roller may be in an idle state at the target rotation speed. After the correction of to-be-engaged correction roller is completed, the controller on the image-forming apparatus may send the medium conveying command to close the clutch. At this point, the motor may drive the correction roller to rotate, such that the medium 30 may be conveyed forward.

It should be noted that the correction process of the correction roller may be realized through manners including a timing manner or an image-forming process control, and the like. In the timing manner, when the medium 30 is conveyed to the correction roller, the preset time may be counted, or the medium 30 may be determined to have been corrected after timing a preset time based on the paper feeding signal; and then the medium conveying command may be sent to match the image-forming process. The paper feeding cartridge or manual paper feeding tray may convey the medium 30 toward the correction roller based on the paper feeding signal. In the image-forming process control manner, after the correction of the correction roller is completed, the medium 30 may stay at the correction roller. When the image-forming process starts or when the image-forming process proceeds to the medium conveying moment determined according to the time sequence, the medium conveying command may be sent to cause the motor to drive the correction roller. The medium conveying time may be a preset time after the image-forming process is started or a preset time before the start or the like, which may not be limited in the present disclosure. Obviously, the medium-conveying part 203 may also be other conveying parts besides the correction roller, which may be all within the implementation scope of the present disclosure.

In another embodiment, the manner of the controller determining that the medium-conveying part starts conveying the medium may include determining that the medium enters the first preset region corresponding to the medium-conveying part when the medium-conveying part is in the rotating state. When the medium-conveying part is in the rotating state driven by the motor, the medium may be in contact with the medium-conveying part. That is, when entering the first preset region of the medium-conveying part, the medium-conveying part may drive the medium through the contact friction force. Therefore, it determines that the medium-conveying part starts conveying the medium. The implementation manner in one embodiment is described in detail hereinafter.

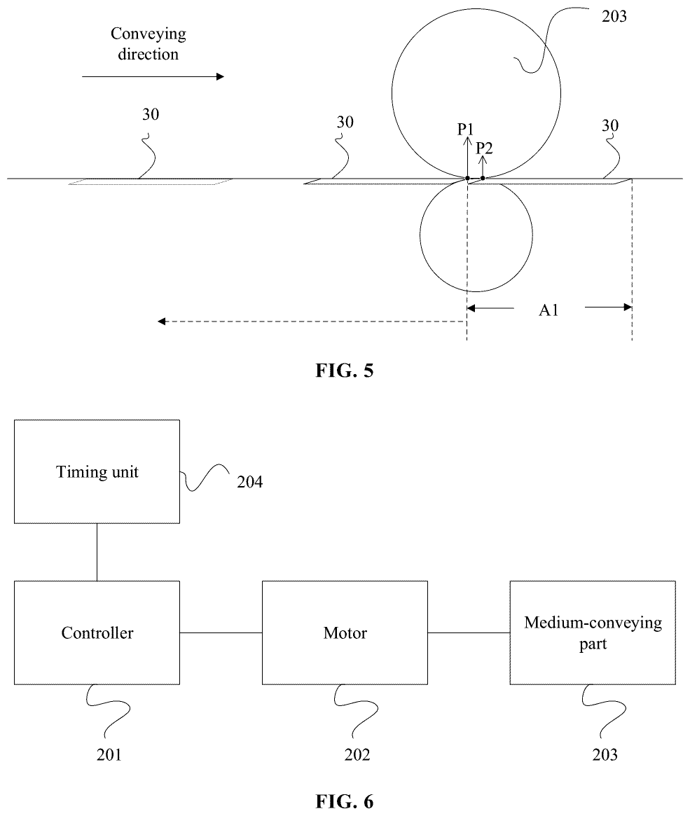

FIG. 5 illustrates another medium-conveying schematic of a medium-conveying part provided by exemplary embodiments of the present disclosure.

Referring to FIG. 5, at the conveying scenario of the medium 30 in some embodiments, according to the medium-conveying direction, when the medium 30 enters the first preset region of the medium-conveying part 203 and the front end of the medium 30 just contacts the medium-conveying part 203, that is, when the front end of the medium 30 reaches the position of the point P1 shown in FIG. 5, the medium-conveying part 203 may begin to perform conveying the medium 30; and when the rear end of the medium 30 just exits the medium-conveying part 203, that is, when the rear end of the medium 30 reaches the position of the P2 point shown in FIG. 5 (the position of the P1 point and the position of the P2 point may be coincided with each other), the medium-conveying part 203 may complete conveying the medium 30.

In some embodiments, the first preset region may be a region that the medium passes through when the medium-conveying part conveys the medium. With the front end of the medium as the reference, from the time when the front end of the medium just contacts the medium-conveying part to the time when the rear end of the medium just exits the medium-conveying part, the region that the medium's front end passes through may be the first preset region, that is, the region A1 shown in FIG. 5. In other embodiments, the first preset region may not be limited to the region A1 shown in FIG. 5. According to the medium-conveying direction, after above region may extend or reduce a preset distance along the front and the rear (two directions) to form a region which may be also defined as the first preset region.

In some embodiments, the manner for the controller to determine that the medium-conveying part starts conveying the medium may include a timing determination manner or a determination manner by the combination of timing and medium conveying position detection. Each of above determination manners is described in detail hereinafter.

### Determination Manner Through Timing

FIG. 6 illustrates another schematic of a motor drive control architecture of the image-forming apparatus provided by exemplary embodiments of the present disclosure.

Referring to FIG. 6, compared with the motor drive control architecture of the image-forming apparatus provided by one embodiment shown in FIG. 2, in one embodiment shown in FIG. 6, the image-forming apparatus may further include a timing unit 204. The timing unit 204 may perform timing according to the control instruction of the controller 201.

In some embodiments, from the time when the medium conveying command is sent, exemplarily, from the time when the controller 201 for controlling medium conveying sends the medium conveying command to the paper feeding tray to feed the medium 30 into the paper path, the first preset time may be counted, and it determines that the medium 30 enters the first preset region after the first preset time. The pickup clutch on the paper feeding tray may receive the medium conveying command to be closed, such that the pickup motor may drive the pickup roller to send the medium 30 into the paper path. Or, when the medium 30 is waiting at a fixed position such as the correction roller, the conveying part at the fixed position after the controller sends the medium conveying command, the medium 30 may pass through the medium-conveying part 203 as the medium 30 continues to be conveying forward, such that the preset time may be counted, and it determines that the medium enters the first preset region after the first preset time. The medium conveying command may be a paper feeding signal that causes the paper feeding tray or manual paper feeding tray to pick up paper, or a medium conveying signal sent based on the image-forming process, or the medium conveying command or clutch closing signal mentioned in above embodiments, or an internal transmission signal based on the image-forming process and medium conveying time sequence control within the controller 201. All signals used to drive medium conveying and pass through medium-conveying part may be within the implementation scope of the present disclosure.

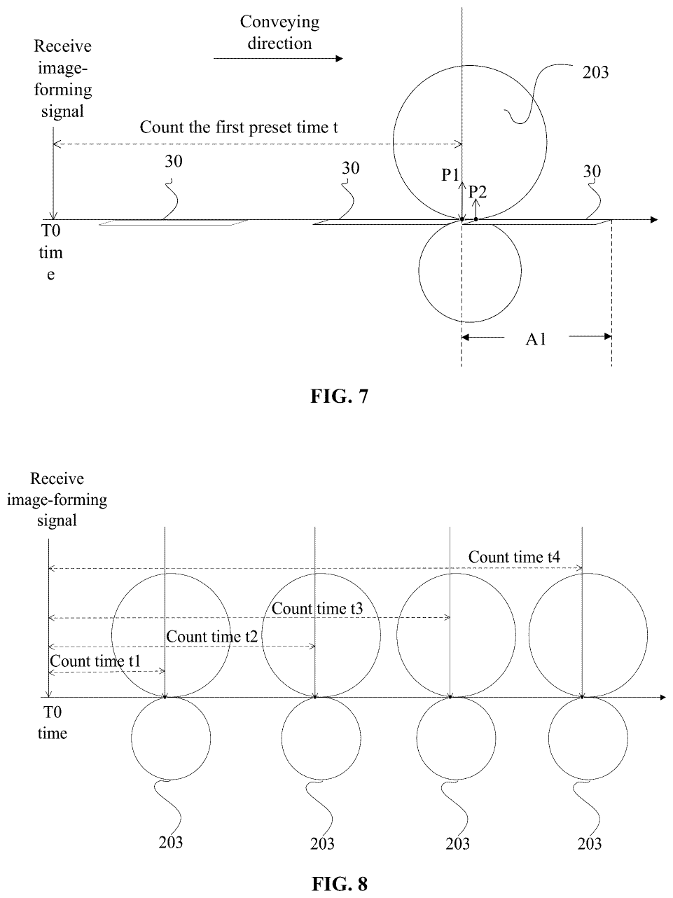

FIG. 7 illustrates a schematic of determining that the medium enters the first preset region provided by exemplary embodiments of the present disclosure.

Referring to FIGS. 6 and 7, the controller 201 may receive the image-forming signal at time to, send a timing instruction to the timing unit 204 at time to, and control the timing unit 204 to count the first preset time t. When the controller 201 determines that the timing unit 204 has completed counting, it determines that the medium enters the first preset region. Exemplarily, the first preset region may be the region A1 shown in FIG. 4. When the controller 201 determines that the timing unit 204 has completed counting, that is, after the first preset time t has passed from time to, the controller 201 determines that the front end of the medium just contacts the medium-conveying part 203, that is, the front end of the medium just reaches the position of the P1 point shown in FIG. 4. In one embodiment, before determining that the medium 30 enters the first preset region, the motor 202 may drive the medium-conveying part 203 to rotate, such that the medium 30 may be conveyed by the medium-conveying part 203 when the medium 30 enters the first preset region.

In some embodiments, when the types of the medium-conveying parts 203 are different, corresponding first preset time lengths may be different.

FIG. 8 illustrates a schematic of first preset time classification provided by exemplary embodiments of the present disclosure.

Referring to FIG. 8, exemplarily, the types of medium-conveying parts 203 may include the paper feeding roller, the transferring roller, the fixing roller and the discharging roller. The first preset time t corresponding to above different types of medium-conveying parts 203 may be time t1, time t2, time t3 and time t4 respectively. For a same image-forming signal, the first preset time t corresponding to different types of medium-conveying parts 203 may be the time for the medium to be conveyed to the positions of the P1 points of all types of medium-conveying parts 203 from the time of pre-detecting that the controller receives the image-forming signal, that is, the time for the same medium to reach the paper feeding roller, the transferring roller, the fixing roller and the discharging roller respectively.

In some embodiments, when the medium sizes are different, corresponding first preset time lengths may be different. The image-forming apparatus may be configured with multiple paper feeding trays; and the paper feeding trays may load paper of different sizes. Exemplarily, the paper feeding trays may include a paper feeding tray containing A4 paper, a paper feeding tray containing A5 paper, a paper feeding tray containing paper of multiple types and sizes and the like. Since the positions of the paper feeding trays of different paper sizes are different or paper of different sizes have different positions on the paper feeding trays, the starting points for conveying papers of different sizes may be different. Therefore, the time required for papers of different sizes to enter the first preset region may be different. In such case, actual time length of the first preset time may be configured according to the size of the medium currently selected by the user.

### Determination Manner Through Detecting Medium-Conveying Position

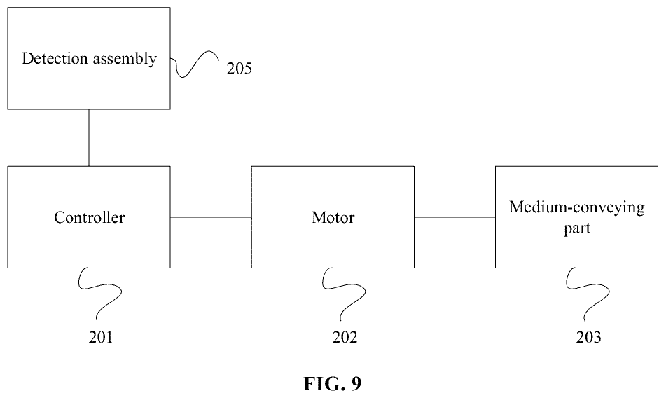

FIG. 9 illustrates another schematic of a motor drive control architecture of the image-forming apparatus provided by exemplary embodiments of the present disclosure.

Referring to FIG. 9, compared with the motor drive control architecture of the image-forming apparatus provided by one embodiment shown in FIG. 2, in one embodiment shown in FIG. 9, the image-forming apparatus may further include a detection assembly 205 which may be configured to detect the conveying position of the medium. In some embodiments, the detection assembly 205 may be the paper detection sensor 120 shown in FIG. 1.

In some embodiments, the controller 201 may determine whether the medium enters or exits the first preset region according to the detection information of the detection assembly 205. According to the detection information of the detection assembly 205 of the image-forming apparatus, if current conveying position of the medium is determined to reach the first reference position, it determines that the medium enters the first preset region. The detection assembly may be configured to detect the conveying position of the medium, and the first reference position may be the position when the medium reaches the medium-conveying part. Exemplarily, the first preset region of the medium-conveying part 203 may be the first preset region A1 shown in FIG. 4; and if the controller 201 determines that the front end of the medium reaches the position of the P1 point (the first reference position) according to the detection information of the detection assembly 205, it determines that the medium enters the first preset region A1 of the medium-conveying part 203.

In addition, the detection information of the detection assembly 205 may also include determining whether the medium enters the second preset region located downstream of the medium-conveying part 203. When the detection assembly 205 detects the medium-conveying part in the front end of the second preset region (the third reference position), it determines that the medium is already in the medium conveying stable state of the medium-conveying part based on the type or medium size of the medium-conveying part, thereby selecting suitable control strategy. Obviously, in one embodiment, if the detection assembly 205 detects that the rear end of the medium exits the first reference position, it determines that the medium has left the first preset region and entered the second preset region. At this point, it can also be shown that the medium is already in the medium conveying stable state by the medium-conveying part.

The medium conveying stable state of the medium-conveying part may refer to a state that the medium-conveying part conveys the medium at a stable target conveying speed, after the instability of the motor rotation speed caused when the medium is initially conveyed by the medium-conveying part is transformed into a stable state of the motor at the target rotation speed under the adjustment of the second control strategy.

In other embodiments, the first reference position may also be the position the medium reached after counting the third preset time based on the position at the first preset distance before the medium-conveying part. When the controller 201 determines the preset distance before the medium is currently conveyed to the medium-conveying part according to the detection information of the detection assembly 205, the controller 201 may send a timing instruction to the timing unit 204 and control the timing unit 204 to count the third preset time. When the controller 201 determines that the timing unit 204 has completed counting (the third preset time), it determines that the medium enters the first preset region.

The above is a detailed description of different manners for the controller to determine that the medium enters the first preset region.

In some embodiments, before the medium-conveying part conveys the medium, executing the first control strategy to control the motor to rotate at the target rotation speed may include before determining that the medium enters the first preset region, executing the first control strategy to control the motor to drive the medium-conveying part to rotate. At this point, the motor may be in the idle state to rotate at the target rotation speed.

The process of determining before the medium enters the first preset region may include after receiving the medium conveying signal and before determining that the medium enters the first preset region (during such period of time), the motor may be controlled to drive the medium-conveying part to rotate by executing the first control strategy.

In some embodiments, the first control strategy may be configured to control the motor to rotate at the target rotation speed based on the first parameter, and the second control strategy may be configured to control the motor to rotate at the target rotation speed based on the second parameter, where the first parameter may be different from the second parameter. The output capacity of the motor at the same speed may be different in the idle state and in the load state. When the medium starts to be conveyed by the medium-conveying part, the medium may cause the motor rotation speed to fluctuate due to the interference of the load change. Therefore, the control strategy may be adjusted when the medium-conveying part start conveying the medium, and the parameters on the control strategy may be changed to be matched with the speed fluctuation caused by load interference. In such way, the motor rotation speed may be quickly stabilized at the target rotation speed, and the medium-conveying part may quickly and stably convey the medium at the first conveying speed. The first conveying speed may be the conveying speed at which the medium-conveying part is controlled by the controller to convey the medium.

It should be noted that when the motor is in the idle state at the target rotation speed, the driving speed for driving the medium-conveying part may be the first conveying speed when conveying the medium. However, in some application scenarios, such as the situation where the medium-conveying part rotates at different speeds in the idle state and in the full-load state, the driving speed for driving the medium-conveying part by the motor in the idle state may be the second conveying speed different from the first conveying speed, which may be also within the implementation scope of the present disclosure.

When it determines that the medium-conveying part start conveying the medium, executing the first control strategy may be switched to executing the second control strategy to control the motor to rotate at the target rotation speed to drive the medium-conveying part and convey the medium at the first conveying speed, thereby improving the stability of the rotation speed of the motor when transitioning from the idle state to the medium conveying state.

In some embodiments, a speed adjustment unit may be disposed inside the image-forming apparatus. The speed adjustment strength may be configured to eliminate the deviation between current rotation speed of the motor and the target rotation speed. The adjustment strength of the speed adjustment unit to the rotation speed of the motor under the first parameter may be less than the adjustment strength of the speed adjustment unit to the rotation speed of the motor under the second parameter. The adjustment strength of the speed adjustment unit to the motor rotation speed refers to at least one of the adjustment amplitude or the number of adjustments made by the speed adjustment unit to current rotation speed of the motor. The adjustment amplitude of the adjustment to current rotation speed of the motor refers to the gap between current rotation speed and the target rotation speed of the motor. The motor current or voltage may be changed to increase or decrease the motor rotation speed to achieve the target rotation speed. The number of adjustments is the sum of the cumulative number of adjustments to the motor rotation speed during the process of adjusting current rotation speed of the motor to the target rotation speed. Taking the medium-conveying part in the present disclosure as an example, when the medium-conveying part is in the idle state, the interference received by the motor may be relatively small, the adjustment amplitude of the speed adjustment unit to current rotation speed of the motor under the first parameter may be relatively small, and the motor rotation speed may be quickly maintained at the target rotation speed within a small fluctuation range, thereby ensuring that the conveying speed of the medium-conveying part remains at the first conveying speed. When the medium-conveying part is converted from the idle state to the loaded state of conveying the medium, the motor's instantaneous speed may decrease due to the load change. The speed adjustment unit controlled by original first parameter may have a weak capability to restore the rotation speed to original rotation speed, the recovery time may be relatively long, and the adjustment range for the rotation speed per unit time may be relatively small. However, after the input parameter of the speed adjustment unit is switched to the second parameter, the rotation speed adjustment capability may be improved. That is, the speed adjustment range per unit time may be increased, such that the motor rotation speed may quickly return to original rotation speed. Therefore, the conveying speed of the medium-conveying part may be stably maintained at the first conveying speed and the medium may be conveyed at such conveying speed even when the load changes. In another implementation manner, the speed adjustment unit may mainly adjust the rotation speed of the motor by the number of adjustments. When the motor's instantaneous speed decreases due to load changes, the speed adjustment unit controlled by original first parameter may have a weak capability to restore the rotation speed to original rotation speed, the recovery time may be relatively long, and the number of adjustments required to restore the rotation speed to the target rotation speed may be relatively high. However, after the input parameter of the speed adjustment unit is switched to the second parameter, the speed adjustment capability may be improved. That is, the number of rotation speed adjustments required when the motor rotation speed returns to the target rotation speed may be reduced, such that the motor rotation speed may quickly return to the original rotation speed. In other embodiments, the rotation speed of the motor may also be adjusted based on the adjustment amplitude and the number of adjustments, which may not be limited in embodiments of the present disclosure.

In an implementation process, the speed adjustment unit may be the control unit that implements the speed adjustment strategy. The first control strategy may include a speed adjustment strategy for controlling the motor output under the first parameter, and the second control strategy may include a speed adjustment strategy for controlling the motor output under the second parameter. When the medium-conveying part starts conveying the medium, the capability of the speed adjustment strategy to stabilize the motor at the target rotation speed under the second parameter may be greater than the capability of the speed adjustment strategy to stabilize the motor at the target rotation speed under the first parameter. Such capability has been described previously for the adjustment strength in the speed adjustment unit, which may not be described in detail herein. As a result, the motor may be quickly adjusted to maintain the medium-conveying part to convey the medium at the first conveying speed. That is, before the medium is conveyed by the medium-conveying part, after the medium-conveying part starts conveying the medium, the speed adjustment unit may adjust the motor rotation speed more strongly. Therefore, it ensures that the motor rotation speed may be stabilized at the target rotation speed while the medium is conveyed by the medium-conveying part.

In some embodiments, both the first parameter and the second parameter may be proportional-integral-derivative (PID) control parameters. The speed adjustment strategy may be the proportional-integral-derivative control parameter. That is, the controller may perform PID control on the motor based on the first parameter or the second parameter to drive the medium-conveying part to convey the medium at a corresponding conveying speed. The proportional-integral-derivative control may be performed by three input parameters including a proportional parameter P, an integral parameter I and a derivative parameter D. The first parameter and the second parameter may each be a parameter input group containing three parameters. The difference between the second parameter and the first parameter may be that at least one of three parameters of the second parameter may be different from three parameters of the first parameter, which result in different control strategies outputted by the speed adjustment strategy.

Various technical solutions provided by the present disclosure are described in detail through some embodiments hereinafter.

### Exemplary Embodiment One

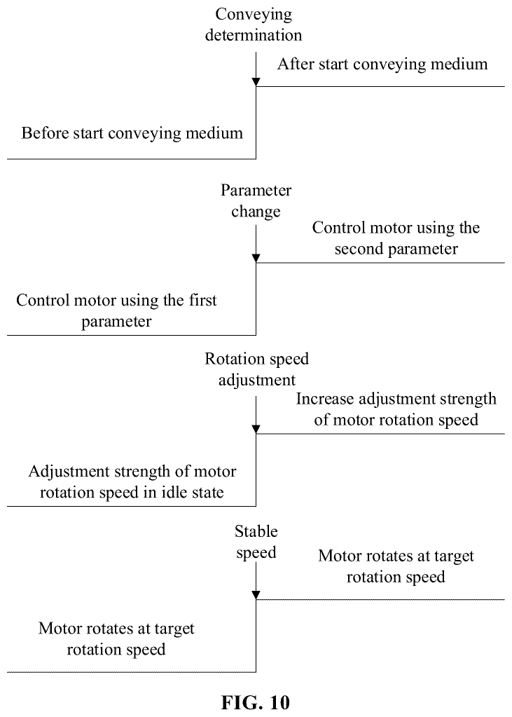

FIG. 10 illustrates a schematic of control strategy switching provided by exemplary embodiments of the present disclosure.

Referring to FIG. 10, before the controller determines that the medium is conveyed by the medium-conveying part, exemplary, after receiving the medium conveying signal and before the medium-conveying part starts conveying the medium, the controller may execute the first control strategy. For example, the controller may control the motor to rotate at the target rotation speed according to the first parameter included in the first control strategy and enter the idle state.

After the medium is conveyed by the medium-conveying part, the load on the motor may increase, which may reduce the driving force provided to the medium-conveying part, thereby reducing the conveying speed of the medium-conveying part, and also affect the stability of the conveying speed of the medium-conveying part and even affect the image-forming effect. Therefore, in one embodiment, when the medium is in the first preset region conveyed by the medium-conveying part and the motor starts to drive the medium-conveying part to rotate at the target rotation speed, the controller may switch from executing the first control strategy to executing the second control strategy. For example, after the controller switches to execute the second control strategy, the controller may change from controlling the motor based on the first parameter to controlling the motor based on the second parameter included in the second control strategy, thereby enhancing the adjustment strength of the motor rotation speed. As a result, the medium-conveying part may maintain a stable conveying speed after changing from the idle state to the medium conveying state. That is, the motor remains at a stable rotation speed before and after the control strategy is switched, such that the medium-conveying part may convey the medium at a stable conveying speed.

In another embodiment, in the case where the medium-conveying part is driven by the motor to rotate at the first conveying speed, when the controller determines that the medium is conveyed by the medium-conveying part, exemplarily, when the medium enters the first preset region of the medium-conveying part according to the conveying direction and the medium-conveying part contacts the medium and starts conveying the medium, the controller may switch from executing the first control strategy to executing the second control strategy. For example, after the controller switches to execute the second control strategy, the controller may change from controlling the motor based on the first parameter to controlling the motor based on the second parameter included in the second control strategy, thereby enhancing the adjustment strength of the motor rotation speed. Therefore, after the medium-conveying part changes from the idle state to the medium conveying state, the stable rotation speed of the motor may be maintained, which may ensure that the medium-conveying part remains at the first conveying speed before and after the control strategy is switched.

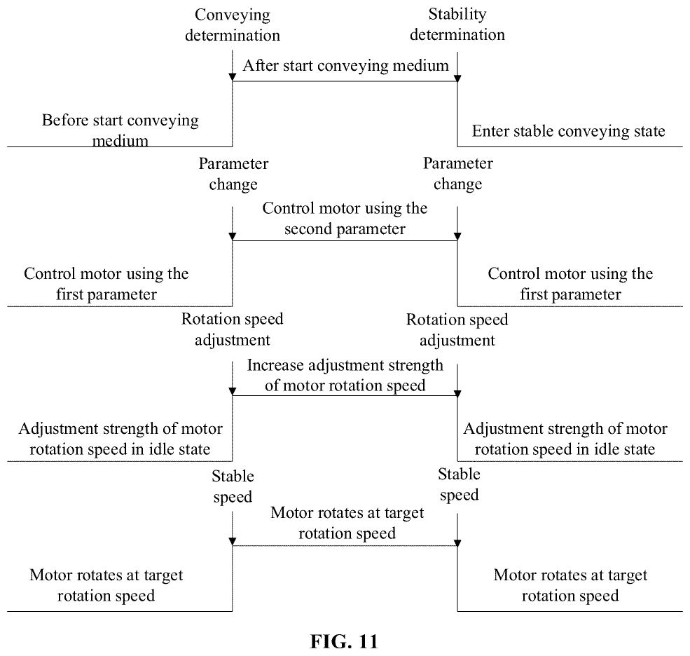

In some embodiments, referring to FIG. 11, after exemplary step S102, the control method may further include exemplary step S103. At S103, after determining that the medium-conveying part starts conveying the medium and a preset time has passed, the controller may switch to execute the first control strategy to control the motor to rotate at the target rotation speed.

When the medium-conveying part start conveying the medium, by counting the preset time, it can be known that the adjustment of the motor rotation speed by the second control strategy has been completed. The preset time may be greater than the adjustment time of the motor rotation speed based on the second control strategy, such that after the motor stabilizes at the target rotation speed, the medium-conveying part may convey the medium at a stable first conveying speed. At this point, the medium may be in stable conveying state. Or the time length of the preset time may also include the time for the medium to exit the first preset region corresponding to the medium-conveying part. That is, after the medium exits the medium-conveying part, the first control strategy may be executed to control the motor to rotate at the target rotation speed. Obviously, the timing of switching the first control strategy may also be when the medium is conveyed by the medium-conveying part, and the control strategy may only need to be changed after the adjustment is completed.

In some embodiments, the manner for the controller to determine the load required for medium conveying which is applied to the medium-conveying part may include a timing determination manner, or a determination manner by the combination of timing and medium conveying position detection, or a determination manner by the combination of timing and medium conveying signal. Each of above determination manners is described in detail hereinafter.

In some embodiments, when the medium-conveying part is in the rotating state before conveying the medium, the second preset time may be counted after determining that the medium enters the first preset region; and after the second preset time, it determines that the rotation speed of the motor has been adjusted to the stable state. The second preset time may be configured when or after the medium exits the first preset region of the medium-conveying part, or the medium may be conveyed by the medium-conveying part in the stable conveying state. In such stable conveying state, in one embodiment, the medium-conveying part may convey the medium at the stable first conveying speed.

When the controller 201 determines that the medium enters the first preset region, the controller 201 may send a timing instruction to the timing unit 204 and control the timing unit 204 to count the second preset time. When the controller 201 determines that the timing unit 204 has completed counting (the second preset time), it determines that the medium may be in the stable conveying state, or the medium exits the first preset region corresponding to the medium-conveying part.

In some embodiments, when the types of the medium-conveying parts 203 are different, corresponding second preset time lengths may be different. Exemplarily, the types of medium-conveying parts 203 may include the paper feeding roller, the transferring roller, the conveying roller, the fixing roller and the discharging roller. Different types of medium-conveying parts 203 mentioned above may be located in different positions, such that the time lengths required for the medium to exit all types of medium-conveying parts 203 may be different.

In some embodiments, the image-forming apparatus may be configured with multiple paper feeding trays; and the paper feeding trays may load paper of different sizes. Exemplarily, the image-forming apparatus may include a paper feeding tray containing A4 paper, a paper feeding tray containing A5 paper, and the like. The time required for paper of different sizes to exit the first preset region may be different. In such case, the actual time length of the second preset time may be configured according to the size of the medium currently selected by the user. When the medium sizes are different, corresponding second preset time lengths may be different.

In some embodiments, the controller 201 may also determine that the motor rotation speed has been adjusted according to the medium conveying position provided by the detection assembly 205.

In an implementation manner, the controller 201 may determine whether the medium reaches the second reference position according to the medium conveying position provided by the detection assembly 205. If the medium is determined to reach the second reference position, it determines that the motor rotation speed has been adjusted to the stable state. The second preset time may be configured to be when or after the medium exits the first preset region of the medium-conveying part or when the medium is conveyed by the medium-conveying part and already in the stable conveying state. For such stable conveying state, in one embodiment, the medium-conveying part may convey the medium at the stable first conveying speed. In an implementation manner of FIG. 5, when the medium is determined to reach the stable state, it may focus on whether the rear end (tail) of the medium exits the medium-conveying part. Exemplarily, when the rear end of the medium 30 reaches the position of the P2 point shown in FIG. 5 (the position of the P1 point and the position of the P2 point may be coincided with each other), it determines that the medium just exits the medium-conveying part, that is, it determines that the medium exits the first preset region. At this point, the medium-conveying part may no longer convey the medium, the motor may re-enter the idle state, and it may switch to execute the first control strategy to control the motor.

Obviously, as disclosed above, the timing of switching to the first control strategy may be performed when the medium is in the stable conveying state. Therefore, the second reference position may be configured at a position where the medium has not left the medium-conveying part. At the second reference position, the adjustment of the motor rotation speed by the second control strategy has been completed; and at this point, the medium may be stably conveyed by the medium-conveying part at the first conveying speed.

In other embodiments, the second reference position may also be the position the medium reached after counting the fourth preset time based on the position at the second preset distance before the medium-conveying part. The controller 201 may determine whether the medium reaches the position of the second preset distance after the medium-conveying part according to the medium-conveying position provided by the detection assembly 205. When it determines that the medium has reached such position, the controller 201 may send a timing instruction to the timing unit 204 to control the timing unit 204 to count the fourth preset time. When the controller 201 determines that the timing unit 204 completes counting (the fourth preset time), the controller 201 may determine that the medium conveying has reached the stable state, or the medium has left the medium-conveying part.

In some embodiments, when the medium-conveying part is in the stopped state during the medium conveying process and the medium has reached the first preset region that the medium can be conveyed by the medium-conveying part, it determines that the rotation speed of the motor has been adjusted to the stable state after counting the third preset time from the moment that the medium is conveyed by the medium-conveying part. The third preset time may be configured to be when or after the medium exits the first preset region of the medium-conveying part or when the medium is conveyed by the medium-conveying part and already in the stable conveying state.

The controller may send the timing instruction to the timing unit when determining that the medium conveying signal is received and control the timing unit to count the third preset time. When the controller determines that the timing unit has completed timing (the third preset time), the controller may determine that the medium is in the stable conveying state, or the medium may exit the first preset region corresponding to the medium-conveying part.

### Exemplary Embodiment Two

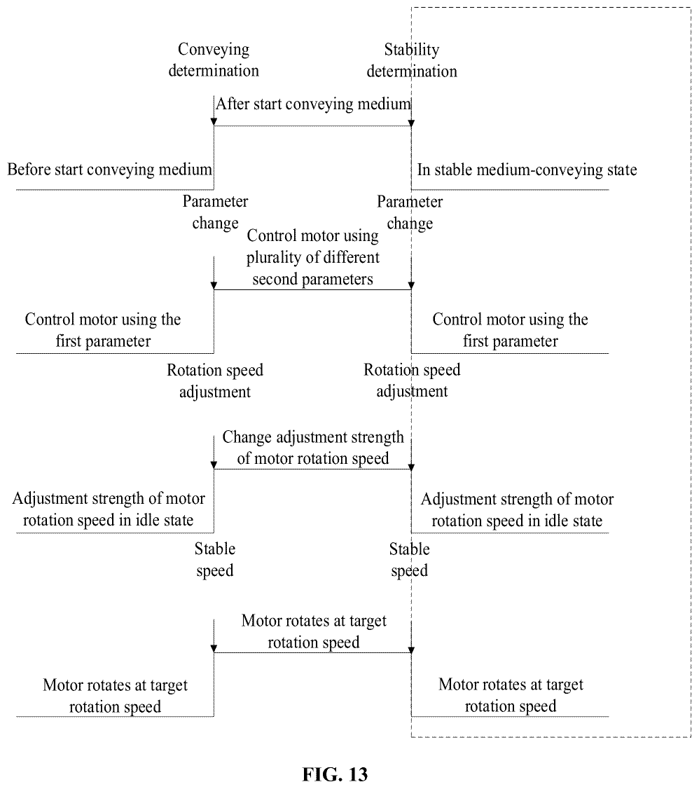

FIG. 13 illustrates another schematic of control strategy switching provided by exemplary embodiments of the present disclosure.

Referring to FIG. 13, before the medium-conveying part starts conveying the medium, exemplarily, before the motor drives the medium to enter the first preset region corresponding to the medium-conveying part for the scenario that the motor drives the medium-conveying part to rotate or before the motor receives the medium conveying signal to drive the medium-conveying part to rotate for conveying the medium, the controller may execute the first control strategy. For example, the controller may control the motor to rotate at the target rotation speed based on the first parameter included in the first control strategy to enter the idle state in which the medium-conveying part is not driven to convey the medium.

After the medium-conveying unit starts conveying the medium, the load on the motor may increase, which may reduce the driving force provided to the medium-conveying part by the load, thereby reducing the conveying speed of the medium-conveying part, and also affect the stability of the conveying speed of the medium-conveying part and even affect the image-forming effect. Therefore, when the controller determines that the medium-conveying part starts conveying the medium, exemplarily, when the front end of the medium just contacts the medium-conveying part according to the conveying direction, the controller may switch from executing the first control strategy to executing the second control strategy. For example, after the controller switches to execute the second control strategy, the speed adjustment unit may be changed from controlling the motor based on the first parameter to controlling the motor based on the second parameter included in the second control strategy, thereby controlling the speed adjustment strength of the motor to be higher. As a result, the medium-conveying part may maintain the stable conveying speed after changing from the idle state to the medium conveying state. That is, the motor may be maintained at the target rotation speed before and after the control strategy is switched.

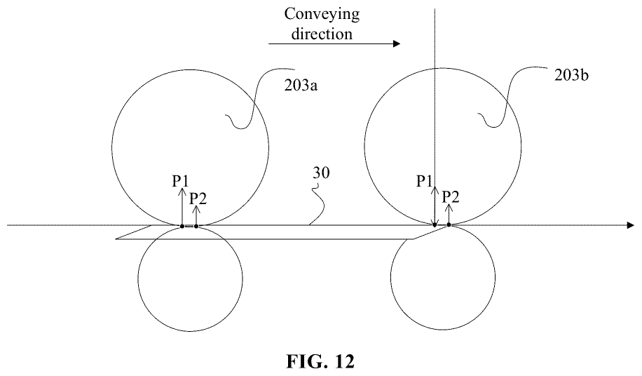

In some embodiments, referring to FIG. 12, the image-forming apparatus may include at least two medium-conveying parts, and the motors may include the first motor that may provide the driving force for at least two medium-conveying parts. Therefore, executing the second control strategy to control the motor to drive the medium-conveying part to convey the medium at the target rotation speed may include controlling the motor to drive the medium-conveying part to convey the medium at the target rotation speed based on a plurality of different second parameters. When each of at least two medium-conveying parts starts conveying the medium, corresponding to different medium-conveying parts, the motor may be controlled to drive at the target rotation speed based on different second parameters.

In one embodiment, multiple medium-conveying part may be driven by same motor, that is, the first motor. When the load on the medium-conveying part changes, the rotation speed of the first motor may also fluctuate due to the load change on the medium-conveying part. The load generated on each medium-conveying part may change differently when conveying the medium starts. Therefore, the second parameters required in the second control strategy may be also different.

The first medium-conveying part and the second medium-conveying part along the medium conveying direction are taken as an example. When the medium starts to be conveyed by the first medium-conveying part, corresponding load conveyed by the first medium-conveying part may increase to cause the first motor rotation speed to fluctuate accordingly. In addition, since the first motor has not carried the medium conveying task before, the fluctuation may be correspondingly large, the parameter may need to be switched to the first second-parameter for adjustment. Within a short adjustment time, such as a time range of 0.1 s, the motor rotation speed may have been adjusted and the first medium-conveying part may stably convey the medium at the first conveying speed until the medium is conveyed to the second medium-conveying part for being conveyed by the second medium-conveying part. Since the medium is a deformable sheet, the medium may curl slightly when two medium-conveying parts convey the medium. When the medium enters subsequent medium-conveying part along the conveying direction, the rotation of previous medium-conveying part may not be affected, but the rotation of next medium-conveying part may be affected. Therefore, when the medium is conveyed on the second medium-conveying part, the load change produced may affect the rotation speed of the first motor. Furthermore, due to the difference between two medium-conveying parts and different load effects of the medium on the first medium-conveying part and the second medium-conveying part, corresponding settings of the second parameters may be also different. Therefore, when the medium starts to be conveyed by the second medium-conveying part, the speed adjustment unit under the second control strategy may switch different second parameters to control the motor to rotate at the target rotation speed, such that the second medium-conveying part may convey the medium at same first conveying speed as the first medium-conveying part.

In one embodiment, before the first medium-conveying part starts conveying the medium, the first medium-conveying part may be in the stopped state, and the second medium-conveying part and subsequent medium-conveying parts may be in the idle state rotating at the first conveying speed. When the first medium-conveying part starts conveying the medium based on the medium conveying signal, the parameter may be switched to the first second-parameter to control the motor to stabilize at the target rotation speed and to make the motor drive the first medium-conveying part to convey the medium at the first conveying speed. When the medium is conveyed to the second medium-conveying part, the parameter may be switched to the second second-parameter to control the motor to stabilize at the target rotation speed and make the motor drive the first medium-conveying part and the second medium-conveying part to convey the medium at the first conveying speed. When the medium is conveyed to the third medium-conveying part, the parameter may be switched to the third second parameter to control the motor to stabilize at the target rotation speed and to make the motor drive the first medium-conveying part, the second medium-conveying part and the third medium-conveying part to convey the medium at the first conveying speed; and so on. Before entering next medium-conveying part, taking the third medium-conveying part as an example, regardless of whether the medium exits the first medium-conveying part or the second medium-conveying part, it may only need to make different adjustments to the second parameters according to the influence on the motor rotation speed caused by the medium which starts to be conveyed by the third medium-conveying part. Stabilizing the motor rotation speed at the target rotation speed may ensure stable conveying speed of the medium between the first medium-conveying part, the second medium-conveying part and the third medium-conveying part or even between more medium-conveying parts.

### Exemplary Embodiment Three

FIG. 12 illustrates a schematic of a medium-conveying scenario provided by exemplary embodiments of the present disclosure.

Referring to FIG. 12, the medium-conveying scenario may include two adjacent medium-conveying parts including the first medium-conveying part 203a and the second medium-conveying part 203b. Such scenario may also include the first motor that provides the driving force for the first medium-conveying part 203a and the second motor that provides the driving force for the second medium-conveying part 203b. The first preset region corresponding to the medium-conveying part may include the first preset region corresponding to the first medium-conveying part 203a and the first preset region corresponding to the second medium-conveying part 203b. For same medium 30, when the medium 30 does not exit the first preset region corresponding to the first medium-conveying part 203a, the front end of the medium 30 may enter the first preset region corresponding to the second conveying part 203b. That is, there may be a scenario where two adjacent medium-conveying parts convey same medium simultaneously. Since the medium 30 passes through the first medium-conveying part 203a and the second medium-conveying part 203b in sequence during the conveying process, it may cause fluctuation in the conveying speed of the medium 30 and affect the medium-conveying stability.

In order to overcome above-mentioned problem, in an implementation manner, when it determines that the first medium-conveying part start conveying the medium, it may switch to execute the second control strategy for controlling the first motor to drive the first medium-conveying part 203a to convey the medium at the first conveying speed; and when it determines that the second medium-conveying part starts conveying the medium, the first motor may be controlled to drive the first medium-conveying part 203a to convey the medium at the first conveying speed based on the third parameter. The third parameter may be different from the first parameter. The adjustment strength of the speed adjustment unit to the rotation speed of the motor under the first parameter may be less than the adjustment strength of the speed adjustment unit to the rotation speed of the motor under the third parameter. When the medium enters the second medium-conveying part 203b, the adjustment intensity of the speed adjustment unit on the rotation speed of the motor may be quickly adjusted. In addition, the third parameter may also be a parameter different from the second parameter. The influence of fluctuations on the rotation speed of the first motor when the medium enters the second medium-conveying part 203b may be different from the influence caused by the medium entering the first medium-conveying part 203a. Therefore, different parameters may be configured to adapt to different speed fluctuations. Obviously, under special case when the effects of the first medium-conveying part 203a and the second medium-conveying part 203b on the first motor rotation speed are corresponding to each other, the third parameter may be configured to be same value as the second parameter.

When the speed adjustment unit uses the PID control strategy to adjust and control the motor, the first parameter and the third parameter may be both a parameter input group containing three parameters. In addition, the difference between the third parameter and the first parameter indicates that at least one of three parameters of the third parameter may be different from the first parameter. In such way, control strategies outputted by the speed adjustment strategy may be different. Similarly, the scenario that the third parameter is different from the second parameter may refer to above-mentioned the scenario that the third parameter is different from the first parameter.

Both medium-conveying parts may be driven by independent motors. In actual applications, due to slight curling characteristics of the media, when the medium is conveyed between two medium-conveying parts, the load fluctuation caused by the medium being conveyed between the two medium-conveying parts may not affect each other. That is, when the medium starts to be conveyed by the second medium-conveying part 203b without exiting the first medium-conveying part 203a, the first motor corresponding to the first medium-conveying part 203a may be already in the stable state at the target rotation speed, and the rotation speed fluctuation of the second medium-conveying part 203b caused by conveying the medium may not affect the first medium-conveying part 203a. Therefore, the first medium-conveying part 203a may maintain current control strategy when the medium enters the first preset region of the second medium-conveying part 203b.

FIG. 13 illustrates another schematic of control strategy switching corresponding to FIG. 12 provided by exemplary embodiments of the present disclosure.

Referring to FIGS. 12 and 13, the first medium-conveying part 203a and the second medium-conveying part 203b may be respectively controlled by the first motor and the second motor which are independent to each other. The controller may execute the first control strategy before determining that the first medium-conveying part 203a conveys the medium. For example, the controller may cause the speed adjustment unit to adjust the first motor to output at the target rotation speed based on the first parameter included in the first control strategy corresponding to the first motor, thereby driving the first medium-conveying part 203a to enter the idle state at the first conveying speed. Similarly, before determining that the second medium-conveying part 203b conveys the medium, the controller may cause the speed adjustment unit to adjust the second motor to output at the target rotation speed based on the first parameter included in the first control strategy corresponding to the second motor, thereby driving the second medium-conveying part 203b to enter the idle state at the first conveying speed. It should be noted that the control strategies of the first medium-conveying part 203a and the second medium-conveying part 203b are independent of each other, such that the first parameter configured to control the first motor and the first parameter configured to control the second motor may be selected according to actual application conditions, and two first parameters may be independent to be not related to each other.

In one embodiment, the first medium-conveying part 203a and the second medium-conveying part 203b may be both in the idle state before conveying the medium. When it determines that the medium enters the first preset region corresponding to the first medium-conveying part 203a, the first medium-conveying part 203a may start conveying the medium. At this point, the control strategy on the first motor may be changed from the first control strategy to the second control strategy; and the control parameter may be changed from the first parameter to the second parameter. In such way, the first medium-conveying part 203a may be quickly stabilized to convey the medium at the first conveying speed. In addition, when the medium enters the first preset region corresponding to the second medium-conveying part 203b, the second medium-conveying part 203b may start conveying the medium. At this point, the control strategy on the second motor may be changed from the first control strategy to the second control strategy, and the control parameter may be changed from corresponding first parameter to corresponding second parameter. In such way, the second medium-conveying part 203b may be quickly stabilized to convey the medium at the first conveying speed.

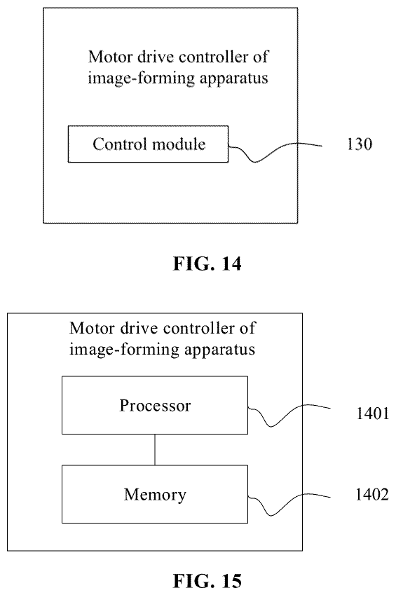

FIG. 14 illustrates a structural schematic of a motor drive controller of an image-forming apparatus provided by exemplary embodiments of the present disclosure.

Referring to FIG. 14, the controller may include a control module 130, configured to, before the medium-conveying part conveys the medium, execute the first control strategy to control the motor to rotate at the target rotation speed; and when the medium-conveying part conveys the medium, switch to execute the second control strategy to control the motor to rotate at the target rotation speed to drive the medium-conveying part to convey the medium.

FIG. 15 illustrates a structural schematic of a motor drive controller of the image-forming apparatus provided by exemplary embodiments of the present disclosure.

Referring to FIG. 15, the motor drive controller may include a processor 1401 and a memory 1402. The memory 1402 may be configured to store at least one instruction. When the instruction is loaded and executed by the processor 1401, the processor 1401 may implement the motor drive control method of the image-forming apparatus provided by any embodiment of the present disclosure.

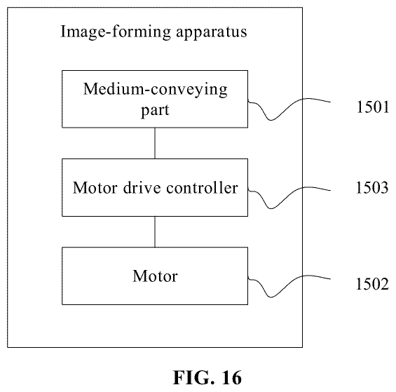

FIG. 16 illustrates a structural schematic of the image-forming apparatus provided by exemplary embodiments of the present disclosure.

Referring to FIG. 16, the image-forming apparatus may include a medium-conveying part 1501, a motor 1502 that provides the driving force to the medium-conveying part, and a motor drive controller 1503 of the image-forming apparatus. The motor drive controller 1503 of the image-forming apparatus may be the motor drive controller of the image-forming apparatus provided by one embodiment shown in FIG. 14.

Embodiments of the present disclosure further provide a computer-readable storage medium where a computer program is stored. When the computer program is executed by the processor, the motor drive control method of the image-forming apparatus provided by any embodiment of the present disclosure may be implemented.

Embodiments of the present disclosure further provide a computer program product, including a computer program or instruction. When the computer program or instruction is executed by the processor, the motor drive control method of the image-forming apparatus provided by any embodiment of the present disclosure may be implemented.

It may be understood that the application may be an application program (e.g., nativeApp) installed on a terminal or may also be a web page program (e.g., webApp) of a browser on the terminal, which may not be limited in embodiments of the present disclosure.

Those skilled in the art may clearly understand that for the convenience and simplicity of description, specific working processes of the system, apparatus and unit described above may be referred to corresponding processes in above-mentioned method embodiments, which may not be described in detail herein.

In some embodiments provided in the present disclosure, it should be understood that the disclosed system, apparatus and method may be implemented in other manners. For example, apparatus embodiments described above may be only exemplary. For example, the division of the unit may be only a logical function division, and there may be another division manner during actual implementation. For example, multiple units or parts may be combined or integrated into another system, or some features may be omitted or not implemented. In addition, mutual coupling or direct coupling or communication connection shown or discussed above may be indirect coupling or communication connection through some interfaces, apparatus or units; and may be electrical, mechanical or other manners.

The units described as separate components may or may not be physically separate; and components shown as units may or may not be physical units, may be located in one place, or may be distributed over multiple network units. A part or all of the units may be selected according to actual needs to achieve the purpose of the solution of this embodiment.

In addition, each functional unit in each embodiment of the present disclosure may be integrated into one processing unit, each unit may exist separately physically, or two or more units may be integrated into one unit. Above-mentioned integrated units may be implemented in the form of hardware, or in the form of hardware plus software functional units.

Above-mentioned integrated units implemented in the form of software functional units may be stored in a computer-readable storage medium. Above-mentioned software functional units may be stored in a storage medium, which may include a plurality of instructions to make a computer device (which may be a personal computer, a server, a network device or the like) or a processor execute some steps of above-mentioned methods in various embodiments of the present disclosure. Above-mentioned storage media may include U disk, mobile hard disk, read-only memory (ROM), random access memory (RAM), magnetic disk or optical disk and other media that may store program codes.

Above-mentioned embodiments of the present disclosure may be exemplary and may not be intended to limit the present disclosure. Any modifications, equivalent replacements, improvements and the like made within the spirit and principles of the present disclosure shall be included within the protection scope of the present disclosure.

It should be noted that above-mentioned embodiments may be only configured to illustrate the technical solution of the present disclosure but may not limit the present disclosure. Although the present disclosure has been described in detail with reference to above-mentioned embodiments, those skilled in the art should understand that the technical solutions described in above-mentioned embodiments may be modified, or equivalent substitutions for some or all of the technical features may be made. However, these modifications or substitutions may not cause the essence of corresponding technical solutions to depart from the scope of the technical solutions of above-mentioned embodiments of the present disclosure.

What is claimed is:

1. A motor drive control method of an image-forming apparatus, wherein the image-forming apparatus includes a medium-conveying part and a motor configured to provide a driving force for the medium-conveying part, the method comprising:
before the medium-conveying part conveys a medium, executing a first control strategy to control the motor to rotate at a target rotation speed; and
when the medium-conveying part conveys the medium, switching to execute a second control strategy to control the motor to rotate at the target rotation speed to drive the medium-conveying part to convey the medium.

2. The motor drive control method according to claim 1, wherein:
the first control strategy is configured to control the motor to rotate at the target rotation speed based on a first parameter, and the second control strategy is configured to control the motor to rotate at the target rotation speed to drive the medium-conveying part to convey the medium based on a second parameter, wherein the first parameter is different from the second parameter.

3. The motor drive control method according to claim 2, wherein:
a speed adjustment unit is disposed inside the image-forming apparatus and configured to eliminate a deviation between current rotation speed and the target rotation speed of the motor, and an adjustment strength of the speed adjustment unit to the rotation speed of the motor under the first parameter is less than an adjustment strength of the speed adjustment unit to the rotation speed of the motor under the second parameter.

4. The motor drive control method according to claim 2, wherein:
the image-forming apparatus includes at least two medium-conveying parts, and motors include a first motor configured to provide a driving force for the at least two medium-conveying parts, and
executing the second control strategy to control the motor to rotate at the target rotation speed to drive the medium-conveying part to convey the medium at the target rotation speed includes:
controlling the motor to drive the medium-conveying part to convey the medium at the target rotation speed based on a plurality of different second parameters, wherein:
when each of the at least two medium-conveying parts starts conveying the medium, the motor is controlled to rotate at the target rotation speed based on different second parameters corresponding to different medium-conveying parts.

5. The motor drive control method according to claim 1, further including:
after determining that the medium-conveying part starts conveying the medium and a preset time has passed, switching to execute the first control strategy to control the motor to drive the medium-conveying part to convey the medium.

6. The motor drive control method according to claim 5, wherein:
when types of medium-conveying parts are different, or medium sizes are different, corresponding preset time lengths are different.

7. The motor drive control method according to claim 1, further including:
after determining that the medium enters a second preset region located downstream of the medium-conveying part, switching to execute the first control strategy to control the motor to drive the medium-conveying part to convey the medium.

8. The motor drive control method according to claim 2, wherein medium-conveying parts include a first medium-conveying part and a second medium-conveying part; and motors include a first motor configured to provide a driving force for the first medium-conveying part and a second motor configured to provide a driving force for the second medium-conveying part, the method further including:
when determining that the first medium-conveying part starts conveying the medium, controlling the first motor to drive the first medium-conveying part to convey the medium at a first conveying speed based on the second parameter; and
when determining that the second medium-conveying part starts conveying the medium, controlling the second motor to drive the second medium-conveying part to convey the medium at a second conveying speed based on the third parameter; and

9. The motor drive control method according to claim 1, determining that the medium-conveying part starts conveying the medium includes:
determining that the medium-conveying part starts conveying the medium based on a medium conveying command sent by the image-forming apparatus.

10. The motor drive control method according to claim 9, wherein:
the image-forming apparatus further includes a clutch part configured to transmit or cut off the driving force provided by the motor to the medium-conveying part; and
determining that the medium-conveying part starts conveying the medium based on a medium conveying command includes determining that the medium-conveying part starts conveying the medium based on a clutch close signal.

11. The motor drive control method according to claim 1, wherein determining that the medium-conveying part starts conveying the medium includes:
when the medium-conveying part is in a rotating state, determining that the medium enters a first preset region corresponding to the medium-conveying part.

12. The motor drive control method according to claim 11, wherein:
the medium-conveying part in the rotating state includes that the motor drives the medium-conveying part to rotate at a first conveying speed, wherein:
When switching to execute the second control strategy to control the motor, the motor rotating at the target rotation speed drives the medium-conveying part to convey the medium at the first conveying speed.

13. The motor drive control method according to claim 11, wherein determining that the medium enters the first preset region corresponding to the medium-conveying part includes:
counting a first preset time from a time point that a medium conveying command is sent, and determining that the medium enters the first preset region, wherein if types of medium-conveying parts or medium sizes are different, corresponding first preset time lengths are different; or
according to detection information of a detection assembly of the image-forming apparatus, if a current conveying position of the medium is determined to reach a first reference position, determining that the medium enters the first preset region, wherein the detection assembly is configured to detect a conveying position of the medium; and the first reference position is a position when the medium reaches the medium-conveying part, or a position of the medium reached after counting a third preset time based on a position at a first preset distance before the medium-conveying part.

14. The motor drive control method according to claim 1, wherein:
a type of the medium-conveying part includes at least one of a paper feeding roller, a conveying roller, a correction roller, a transferring roller, a fixing roller, and a discharging roller.

15. A motor drive controller of an image-forming apparatus, wherein the image-forming apparatus includes a medium-conveying part, and a motor configured to provide a driving force for the medium-conveying part, comprising:
a memory storing program instructions; and
a processor communicatively coupled to the memory and, when the program instructions being executed, configured to:
before the medium-conveying part conveys a medium, execute a first control strategy to control the motor to rotate at a target rotation speed; and
when the medium-conveying part conveys the medium, switch to execute a second control strategy to control the motor to drive the medium-conveying part to convey the medium at the target rotation speed.

16. The motor drive controller according to claim 15, wherein:
the first control strategy is configured to control the motor to rotate at the target rotation speed based on a first parameter, and the second control strategy is configured to control the motor to rotate at the target rotation speed to drive the medium-conveying part to convey the medium based on a second parameter, wherein the first parameter is different from the second parameter.

17. The motor drive controller according to claim 16, wherein:
a speed adjustment unit is disposed inside the image-forming apparatus and configured to eliminate a deviation between current rotation speed and the target rotation speed of the motor, and an adjustment strength of the speed adjustment unit to the rotation speed of the motor under the first parameter is less than an adjustment strength of the speed adjustment unit to the rotation speed of the motor under the second parameter.

18. The motor drive controller according to claim 16, wherein:
the image-forming apparatus includes at least two medium-conveying parts, and motors include a first motor configured to provide a driving force for the at least two medium-conveying parts, and
the processor is further configured to control the motor to rotate at the target rotation to drive the medium-conveying part to convey the medium at the target rotation speed based on a plurality of different second parameters, wherein:
when each of the at least two medium-conveying parts starts conveying the medium, the motor is controlled to rotate at the target rotation speed based on different second parameters corresponding to different medium-conveying parts.

19. The motor drive controller according to claim 15, wherein the processor is configured to:
after determining that the medium enters a second preset region located downstream of the medium-conveying part, switch to execute the first control strategy to control the motor to drive the medium-conveying part to convey the medium.

20. A non-transitory computer-readable storage medium containing a stored program, that when being executed, causes a device where the non-transitory computer-readable storage medium is located to execute a motor drive control method of an image-forming apparatus,
wherein the image-forming apparatus includes a medium-conveying part, and a motor configured to provide a driving force for the medium-conveying part, the method comprising:
before the medium-conveying part conveys a medium, executing a first control strategy to control the motor to rotate at a target rotation speed; and
when the medium-conveying part conveys the medium, switching to execute a second control strategy to control the motor to rotate at the target rotation speed to drive the medium-conveying part to convey the medium.
